(19) United States
(12) Patent Application Publication
(10) Pub. No.: US 2024/0249353 A1
(43) Pub. Date: Jul. 25, 2024

(54) SYSTEM AND METHOD FOR PROVIDING A TRUSTLESS TRADING ENGINE FOR TRADING PLATFORMS

(71) Applicant: Vatnforn, Corp., Deerfield Beach, FL (US)

(72) Inventors: Zorrik Voldman, Deerfield Beach, FL (US); Gregory Barnes, Deerfield Beach, FL (US)

(21) Appl. No.: 18/158,288

(22) Filed: Jan. 23, 2023

(51) Int. Cl. G06Q 40/04; G06F 21/53

(52) U.S. Cl. CPC G06Q 40/04; G06F 21/53; G06F 2221/2105

(57) ABSTRACT

A computing system configured for trustless trading of digital assets via a communications network includes a raft consensus-driven computer network having trusted execution environment (TEE) enclaves for processing security-sensitive programs, and a rich execution environment (REE) for processing of non-security-sensitive programs, a software package for a digital asset exchange executed in the TEE enclaves, the software package configured for receiving an order, transmitting a request to an owner of a digital asset for an electronic signature, receiving an electronic signature from the owner authorizing the order, verifying the electronic signature, and executing the order, wherein the computer network is configured for executing third party attestation on the software package executing in the TEE enclaves, documenting an outcome of the step of executing third party attestation via persistent storage of the outcome, and providing access to the persistent storage of the outcome to parties and operations outside the TEE enclaves.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of trading platforms and exchanges and, more specifically, the claimed subject matter relates to the field of processes for making trading platforms and asset exchanges more transparent and fair for all participants.

### BACKGROUND

A trading platform is a computer software program that is used by an exchange to buy, sell, and trade assets over a network. Various assets can be traded by the trading platform over a communication network with a financial intermediary or directly between the participants or members of the trading platform. This includes assets such as stocks, bonds, currencies, commodities, derivatives, cryptocurrency, digital currency, etc. Said aforementioned assets shall be referred to herein as digital assets.

On a trading platform, ownership and control over digital assets are controlled through keys, and the manner in which keys are managed differs between centralized and decentralized exchanges. Centralized exchanges are centralized platforms that involve third-party oversight over digital assets and are more convenient and easier to use for users of all levels. In addition, these platforms have high liquidity and store both the keys and digital assets on behalf of the user, reducing the risk of losing access to said digital assets. Centralized exchanges, however, are more vulnerable to cyber-attacks and expose customer digital assets to counterparty risk at the hands of the exchange.

Decentralized exchanges are a type of cryptocurrency exchange that allows for direct peer-to-peer cryptocurrency transactions to take place online securely and without the need for an intermediary. Decentralized exchanges do not involve third-party oversight and require that the user exercise self-custody of keys. Despite solving the control issue, with regard to decentralized exchanges, many users fear the potential loss of their keys and losing access to their digital assets. Moreover, decentralized exchanges have low liquidity and rely on users who have found decentralized exchanges complex and hard to use. Such complexity presents an additional risk for cryptocurrency exchange beginners who fall prey to scammers on decentralized exchanges. When compared to their centralized counterparts, decentralized exchanges can be magnitudes slower, computationally expensive, and lacking in confidentiality, which compounds the problems associated with such exchanges.

Therefore, what is needed is a system and method for improving over the problems with the prior art and, more specifically, for more efficient, secure and trustworthy trading platforms for exchanging digital assets.

### BRIEF SUMMARY

In one embodiment, a computing system configured for trustless trading of digital assets via a communications network is disclosed. The system includes: a) a raft consensus-driven computer network comprised of trusted execution environment (TEE) enclaves within which processing of security-sensitive programs is secure from parties and operations outside the TEE enclaves, and a rich execution environment (REE) for processing of non-security-sensitive programs, the raft consensus-driven computer network communicatively coupled to the communications network; b) a software package for a digital asset exchange executed in the TEE enclaves, the software package configured for executing transactions pertaining to digital assets as follows: 1) receiving, via the communications network, an order for a transaction regarding a particular digital asset; 2) transmitting, via the communications network, a request to an owner of said particular digital asset for an electronic signature authorizing said order; 3) receiving, via the communications network, an electronic signature from the owner authorizing said order; 4) verifying said electronic signature; and 5) executing said order for the transaction regarding the particular digital asset; and c) wherein the raft consensus-driven computer network is configured for: 1) executing third party attestation on the software package executing in the TEE enclaves; 2) documenting an outcome of the step of executing third party attestation via persistent storage of said outcome, wherein the outcome defines whether the software package executing in the TEE enclaves is validated; and 3) subsequent to documenting said outcome, providing access, via the communications network, to said persistent storage of said outcome to parties and operations outside the TEE enclaves.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for trustless trading of digital assets via a communications network, in accordance with one embodiment.

FIG. 2 is a block diagram showing the trusted execution environment and rich execution environment for trustless trading of digital assets via a communications network, according to one embodiment.

FIG. 3 is a block diagram showing the main participants in the process for trustless trading of digital assets via a communications network, according to one embodiment.

FIG. 4 is a block diagram showing the interaction of a market participant with a system for trustless trading of digital assets via a communications network, according to one embodiment.

FIG. 5 is a flowchart showing the process of executing orders and attestation in the system for trustless trading of digital assets via a communications network, according to one embodiment.

FIG. 6 is a block diagram showing the process of executing an order in the system for trustless trading of digital assets via a communications network, according to one embodiment.

FIG. 7 is a block diagram showing the raft consensus network of the system for trustless trading of digital assets via a communications network, according to one embodiment.

FIG. 8 is a flow chart depicting the control flow of a raft consensus process in the system for trustless trading of digital assets via a communications network, according to one embodiment.

FIG. 9 is a block diagram depicting a system including an example computing device and other computing devices.

### DETAILED DESCRIPTION

While the claimed embodiments may be described, modifications, adaptations, and other implementations are possible. For example, substitutions, additions, or modifications may be made to the elements illustrated in the drawings, and the compositions and methods described herein may be modified by substituting, reordering, or adding elements to the disclosed compositions or stages to the disclosed methods. Accordingly, the following detailed description does not limit the claimed embodiments. Instead, the proper scope of the claimed embodiments is defined by the appended claims.

The claimed embodiment improve over the prior art by providing a compliant, highly performant, and effectively trustless trading engine for a digital asset exchange. The claimed system provides an automated process for enforcing custody of keys to a digital asset on the owner of said asset, thereby reducing or eliminating the problems associated with an exchange having custody of said keys. The claimed embodiments introduce enforceable integrity, accountability, and transparency—all of which are provable without significantly affecting the speed, efficiency, and low cost that users have come to expect from well-designed trading platforms.

The claimed embodiments are further configured for an automated attestation process that occurs after a transaction has been executed, which speeds up transaction time. Further, the claimed embodiments include a process that allows for the post factum reconstruction and auditing of transaction, including exchange of assets, depositing and withdrawal of assets, assessment of fees, and other activities, thereby increasing the reliability and verifiability of the system and increasing users' trust thereof. Consequently, the disclosed embodiments enjoy the benefit of both centralized and decentralized exchanges. The claimed embodiments further use consensus-based validation to audit the deployment and maintenance of TEE enclaves, and are therefore capable of high transactional throughput, complex operations, and crash fault tolerance, while maintaining a high level of integrity and non-interference assurance, as well as immutability of custody.

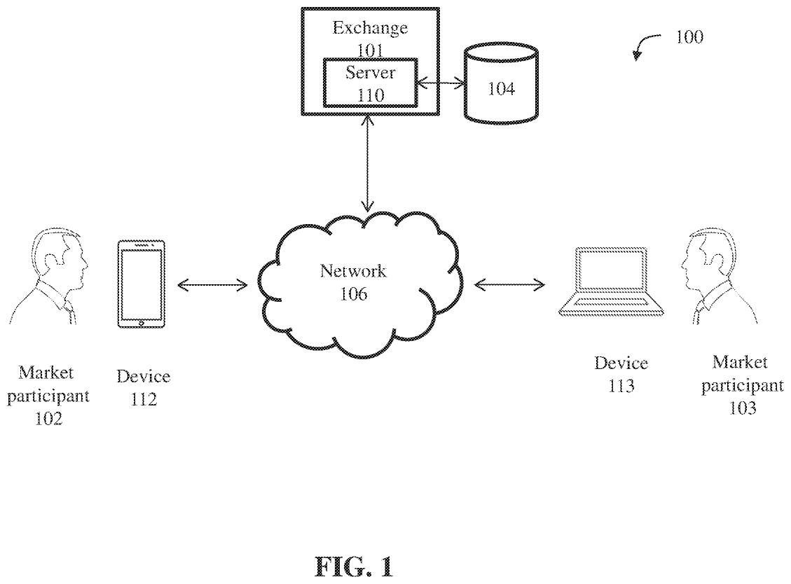

Referring now to the drawing figures in which like reference designators refer to like elements, there is shown in FIG. 1 an illustration of a block diagram showing the network architecture of a system 100 and method for trustless trading of digital assets via a communications network in accordance with one embodiment. A prominent element of FIG. 1 is the exchange 101 comprising a server 110 associated with repository or database 104 and further communicatively coupled with network 106, which can be a circuit-switched network, such as the Public Service Telephone Network (PSTN), or a packet-switched network, such as the Internet or the World Wide Web, the global telephone network, a cellular network, a mobile communications network, or any combination of the above. Server 110 is a central controller or operator for the functionality of the disclosed embodiments, namely, an exchange 102 for facilitating trustless trading of digital assets between users via a communications network. An exchange is a business that allows customers to trade digital assets including stocks, bonds, currencies, commodities, derivatives, cryptocurrency, digital currency, conventional fiat money, etc.

FIG. 1 includes computing devices 112, 113 which may be mobile computing devices such as smartphones, mobile phones, tablet computers, handheld computers, laptops, or the like. In another embodiment, computing devices 112, 113 may be stationary devices such as workstations, desktop computers, servers, laptops, all-in-one computers, or the like. In another embodiment, computing devices 112, 113 are AR or VR systems that may include display screens, headsets, heads-up displays, helmet-mounted display screens, or the like. Computing device 112 corresponds to a market participant 102 engaging in trading of digital assets and computing device 113 corresponds to a market participant 103 also engaging in trading of digital assets. Server 110 may also be a site, a collection of servers, or the like. Devices 112, 113, 110 may be communicatively coupled with network 106 in a wired or wireless fashion.

FIG. 1 further shows that server 110 includes a database or repository 104, which may be any commercially available database, such as a relational database comprising a Structured Query Language (SQL) database stored in a SQL server. Devices 112, 113 may also each include their own database. The repository 104 serves data from a database, which is a repository for data used by server 110 and devices 112, 113 during the course of operation of the disclosed embodiments. Database 104 may be distributed over one or more nodes or locations that are connected via network 106.

Database 104 may include a user record for each user 102, 103. A user record may include: contact/identifying information for the user (name, address, telephone number(s), email address, etc.), user credentials, user login information, user password information, electronic payment information, etc. A user record may also include a unique identifier for each user, user transaction data, user financial statements, user activity logs, etc. A user record may further include demographic data for each user, such as age, sex, income data, race, color, marital status, etc.

FIG. 1 shows an embodiment wherein networked computing devices 112, 113 interact with exchange 101, server 110 and repository 104 over the network 106. It should be noted that although FIG. 1 shows only the networked computers 112, 113, the system of the disclosed embodiments supports any number of networked computing devices connected via network 106. Further, server 110 and units 112, 113 include program logic such as computer programs, mobile applications, executable files or computer instructions (including computer source code, scripting language code, or interpreted language code that may be compiled to produce an executable file or that may be interpreted at run-time) that perform various functions of the disclosed embodiments.

Note that although server 110 is shown as a single and independent entity, in one embodiment, the functions of server 110 may be integrated with another entity, such as a validator, an attestation provider, a ledger provider, etc. Further, server 110 and its functionality, according to a preferred embodiment, can be realized in a centralized fashion in one computer system or in a distributed fashion wherein different elements are spread across several interconnected computer systems. Note also that although a single exchange 101 is shown, the processes and systems of the disclosed embodiments may be applied to any number of exchanges.

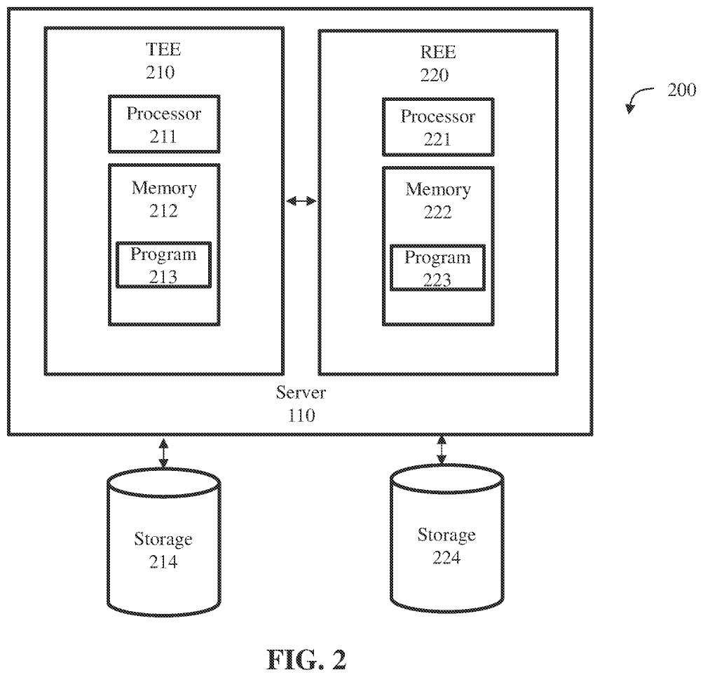

The system and method for trustless trading of digital assets will now be described with reference to FIGS. 2-9 below.

FIG. 2 is a block diagram 200 showing the trusted execution environment (TEE) 210 and rich execution environment (REE) 220 for trustless trading of digital assets via a communications network 106, according to one embodiment. One or more TEE 210 systems can be referred to as a TEE enclave. FIG. 2 shows that server 110 includes a trusted execution environment (TEE) 210 having a processor 211, a memory 212, program(s) 213 executing in said memory, and data storage 214. In one embodiment, resources utilized by the TEE enclave are isolated from resources used by the REE. In another embodiment, memory 212 utilized by the TEE enclave is protected by a hardware access-control mechanism. The claimed embodiments can be implemented with one or more TEE enclaves.

A trusted execution environment (TEE) is a secure system that guarantees code and data loaded inside the system to be protected with respect to confidentiality and integrity. The TEE exercises data integrity, which prevents unauthorized outside entities from altering data, and code integrity, which prevents the code in the TEE from being replaced or modified by unauthorized outside entities. The TEE implements unique, immutable, and confidential architectural security that isolates application code and data in memory. The TEE is an isolated execution environment that provides security features such as isolated execution, integrity of applications executing with the TEE, and confidentiality of their assets. The TEE offers an execution space that provides a higher level of security for trusted applications or program(s) 213 than a rich execution environment (REE).

FIG. 2 also shows that server 110 includes a rich execution environment (REE) 220 having a processor 221, a memory 222, program(s) 223 executing in said memory, and data storage 224. A rich execution environment (REE) refers to a standard operating system with significantly more features and applications than the TEE, and as a result, is vulnerable to attacks. Additionally, the REE does not run trusted programs and does not have the same level of security as the TEE, resulting in a lower security environment.

The TEE 210 runs trusted program(s) 213 such as those configured for executing business logic, such as transactions for digital assets, the exchange of assets, depositing and withdrawal of assets, assessment of fees, and other activities. No party, even the host of the TEE. can see the operations occurring inside the business logic executing on the TEE. Therefore, there are no privileged parties that can use trading data prior to it being available to all market participants. This ensures the premise of fair execution by preventing various trading evils, including front running, order flow reordering, order flow blocking, spread deterioration and privileged rent seeking. In one embodiment, all business logic is open-sourced. The REE 220 runs non-trusted program(s) 223 such as those configured for queuing orders. A secure communications channel may be located between the REE and the TEE enclave. Communication between an application inside the TEE and the REE is strictly defined by the interface of the aforementioned application. Business logic exposed by the secure communications channel between the REE and the TEE enclave is reserved for exchange operations, such as pausing for maintenance and read-only access to select data inside the enclave.

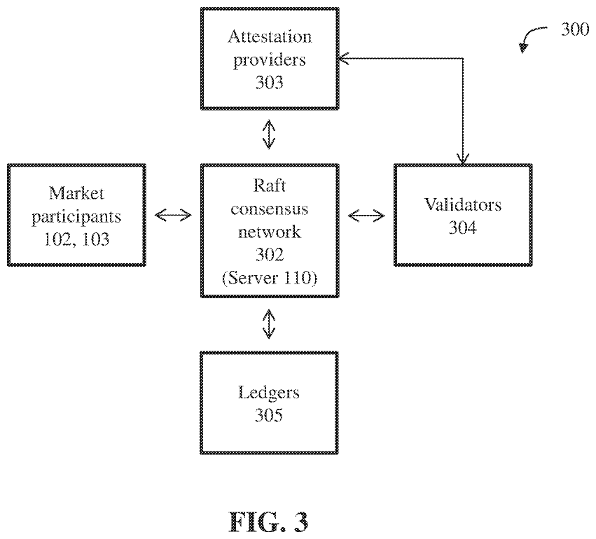

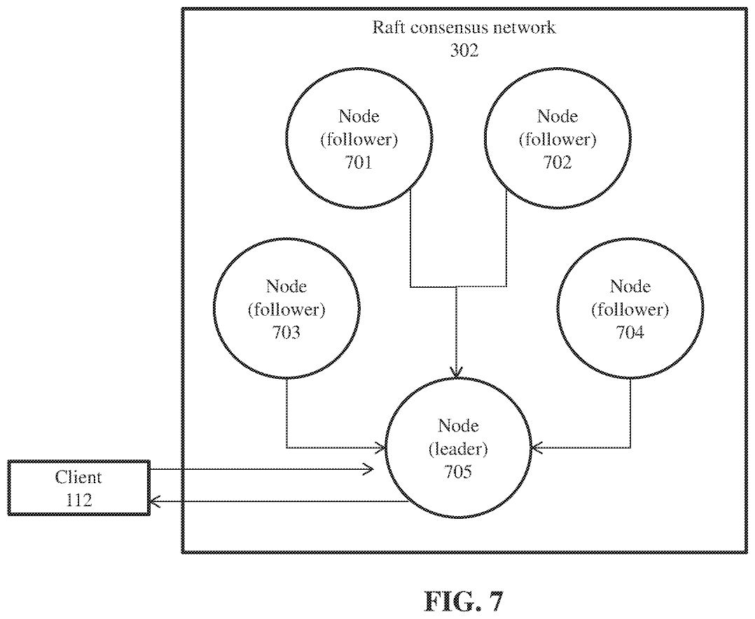

FIG. 3 is a block diagram 300 showing the main participants in the process 500 for trustless trading of digital assets via a communications network 106, according to one embodiment. FIG. 3 shows that server 110 includes a raft consensus network 302 described in more detail with reference to FIG. 7 below. FIG. 3 also shows the market participants 102, 103 of FIG. 1, as well as ledgers 305. A ledger is a record-keeping and public verification mechanism available via network 106. In one embodiment, the ledgers 305 include a public cryptocurrency ledger used as a record-keeping system that maintains market participants' identities in secure and anonymous form, their respective cryptocurrency balances, and a record book of all the genuine transactions executed between market participants. The raft consensus network 302 has access to the ledgers 305 and the ability to commit transactions to said ledger according to the rules set by the market participants.

FIG. 3 also shows validators 304, as well as attestation providers 303. Validators are computing systems dedicated to maintaining the integrity of transactions of the exchange 101. The validator nodes may solve complex computational math problems in order to win the right to verify transactions and be rewarded for said work. This mechanism helps secure the exchange by having compensated outside parties that validate the transactions executed by the exchange 101. Independent validators are compensated to verify the integrity of the exchange as a whole and to verify behavior and dispute against bad actors. Validators can subscribe to log replication (see the description of the raft consensus network 302 below) and native TEE cryptographic attestation to verify that behavior is as intended. Validators are tasked with auditing the business logic executing in the TEE 210 by checking native TEE cryptographic attestation, verifying the TEE enclave image, verifying the Linux kernel, and verifying the application(s). Additionally, validators participate in governance, voting on: future updates, protocol parameters, and select actions taken by the protocol.

Attestation providers 303 provide a service that verifies the trustworthiness of the business logic executed by the TEE enclave. Attestation providers 303 receives evidence from the exchange 101, validates it with security standards, evaluates it against configurable policies, and produces an attestation in response to said evaluation. Attestation providers 303 receive votes from the validators 304 regarding the results of their activities auditing the business logic executing in the TEE 210 (see description of validators above). Attestation providers 303 compile votes from the validators and do or do not provide an attestation to a particular transaction executed by the TEE enclave. Remote attestation can also be performed by independent (non-node) participants.

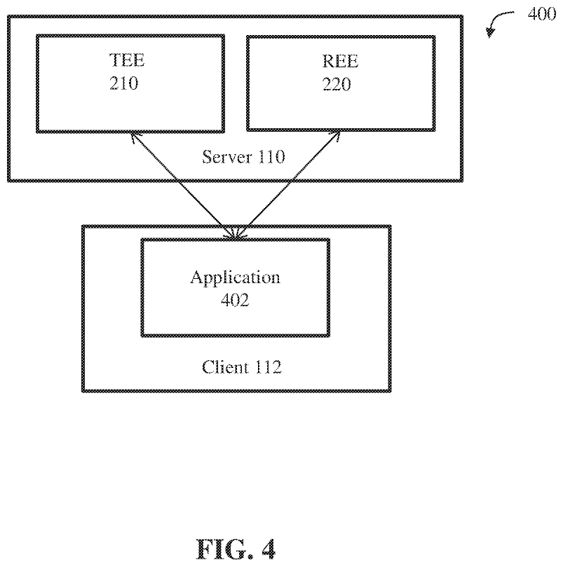

FIG. 4 is a block diagram 400 showing the interaction of a market participant 102 with a system for trustless trading of digital assets via a communications network 106, according to one embodiment. FIG. 4 shows an application 402 executing on the client device 112 of the market participant 102, and how it interacts with the server 110. FIG. 4 shows a client application 402 utilized by the market participant 102 to execute transactions for digital assets, the exchange of assets, depositing and withdrawal of assets, payment of fees, and other activities on the exchange 101. The client application 402 executes on the client device 112 of the market participant 102 and interacts with trusted programs on the TEE 210 of server 110, such as such as those configured for executing business logic, such as transactions for digital assets, the exchange of assets, depositing and withdrawal of assets, assessment of fees, and other activities. The client application 402 also interacts with non-trusted programs on the REE 220 of server 110, such as those configured for queuing orders.

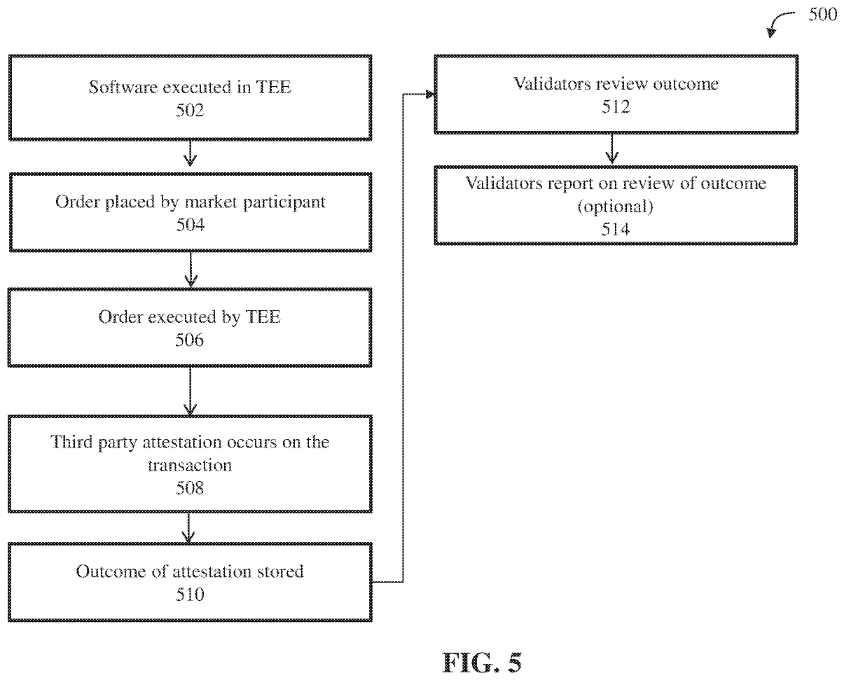

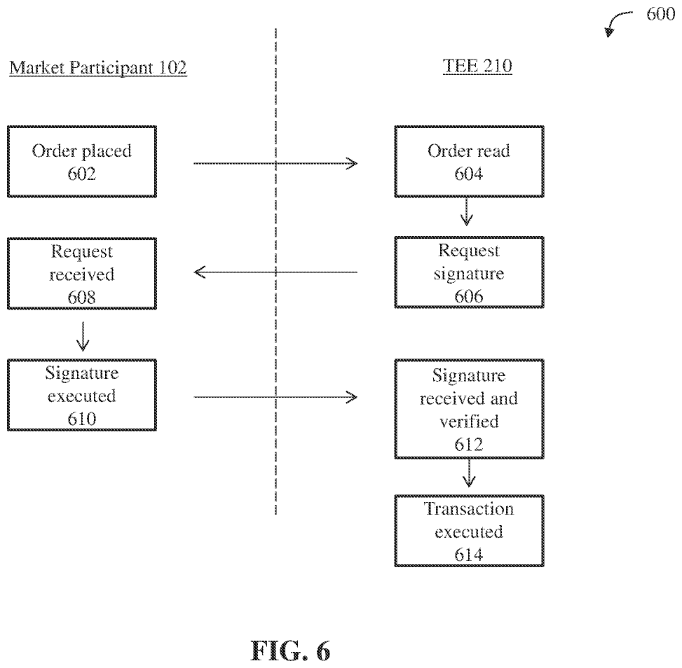

FIG. 5 is a flowchart showing the process 500 of executing orders and attestation in the system for trustless trading of digital assets via a communications network 106, according to one embodiment. Process 500 begins in step 502 wherein a software package (or program 213) is executed in the TEE 210. The software package for a digital asset exchange is configured for executing transactions pertaining to digital assets as follows: receiving an order for a transaction regarding a particular digital asset, transmitting a request to an owner of said particular digital asset for an electronic signature authorizing said order, receiving an electronic signature from the owner authorizing said order, verifying said electronic signature, and executing said order for the transaction regarding the particular digital asset. Said steps performed by the program 213 are described in more detail below with respect to FIG. 6. In step 504, a market participant 102 utilizes his client application 402 to transmit an order (such as an order to purchase a digital asset) to the TEE 210 via network 106. In step 506, the TEE 210 executes said order by executing the needed business logic for purchasing the digital asset identified by the order. Said order execution is described in more detail below with respect to FIG. 6.

In step 508, the raft consensus-driven computer network 302 executes third party attestation on the software package executing in the TEE enclave and, in step 510, documents an outcome of the third-party attestation via persistent storage (such as in storage 214) of said outcome, wherein the outcome defines whether the software package executing in the TEE enclave is validated. In step 512, subsequent to documenting said outcome, access is provided, via the communications network 102, to said persistent storage 214 of said outcome to parties and operations outside the TEE enclave, such as validators 304. In step 514, said validators may report on their review of the documentation and provide (or not provide) a vote to an attestation provider 303 regarding whether said transaction is valid.

FIG. 6 is a block diagram showing the process 600 of executing an order in the system for trustless trading of digital assets via a communications network 106, according to one embodiment. The process 600 of FIG. 6 provides additional detail regarding steps 504 and 506 of process 500 above. In step 602, the market participant 102 utilizes his client application 402 to transmit an order (such as an order to sell a digital asset) to the TEE 210 via network 106. In step 604, the TEE 210 receives the order for a transaction regarding a particular digital asset, and in step 606 transmits, via network 106, a request (such as a TCP request) to the owner of said particular digital asset (i.e., market participant 102) for an electronic signature authorizing said order. In step 608, the market participant 102 receives the request and utilizes his client application 402, in step 610, to execute an electronic signature and transmit it to the TEE 210. In step 612, the TEE 210 receives the electronic signature from the owner authorizing said order and verifies said electronic signature against stored data, such as against a public key that corresponds to the private key used to create the electronic signature. In one alternative, in step 602, market participants may optionally send orders concurrently with a signature, effectively moving straight to step 612. In step 614, the TEE 210 executes said order for the transaction regarding the particular digital asset.

The electronic signature may comprise a digital signature which is a mathematical scheme employing asymmetric cryptography for verifying the authenticity of a message. A digital signature comprises a key generation algorithm that selects a private key and outputs the private key and a corresponding public key, a signing algorithm that, given a message and a private key, produces a signature, and a signature verifying algorithm that, given the message, public key, and signature, either accepts or rejects the message's claim to authenticity.

FIG. 7 is a block diagram showing the raft consensus network 302 of the system 100 for trustless trading of digital assets via a communications network 106, according to one embodiment. Each node 701-705 in the raft consensus network 302 may be a server, a virtual machine executing on a server, a desktop, a workstation, or any computer hardware executing software that provides functionality for other programs or devices. The raft consensus network 302 utilizes a raft consensus algorithm that offers a generic way to distribute a state machine across a cluster of nodes, ensuring that each node in the cluster agrees upon the same series of state transitions. The raft consensus algorithm achieves consensus via an elected leader. A node in a cluster is either a leader or a follower, and can be a candidate in the precise case of an election. The leader node is responsible for log replication to the follower nodes. In this case, the log refers to documentation of the execution of transactions for digital assets, the exchange of assets, depositing and withdrawal of assets, assessment of fees, and other activities.

The leader node regularly informs the follower nodes of its existence by sending a heartbeat message, or a ping sent at regular periods. Each follower node has a timeout (typically between 150 and 300 ms) in which it expects the heartbeat from the leader node. The timeout is reset on receiving the heartbeat. If no heartbeat is received from the leader node, the follower node changes its status to candidate, enters into leader election mode, and starts a leader election, which is described in greater detail below.

Raft consensus takes a leader approach. The cluster has one and only one elected leader node which is fully responsible for managing log replication on the other nodes of the cluster. The leader node can decide on new entries' placement and establishment of data flow between it and the other nodes without consulting other nodes. A leader node leads until it fails or disconnects, in which case a new leader node is elected. When the existing leader node fails or when the algorithm initializes, a new leader node must be elected. If the election is completed successfully (i.e. a single leader node is elected) normal operations are orchestrated by the new leader node. If the election is a failure, a new election occurs. Use of the raft algorithm results in crash tolerance of the system; in case the leader node unexpectedly stops working properly. Use of the raft algorithm also results in the ability to periodically move leader nodes between physical locations, since the leader node can be changed, per the procedure described above.

The leader node is responsible for log replication. The leader node accepts orders, for example, to be executed by the exchange 101. After being appended to the leader node's log as a new entry, each of the orders is forwarded to the follower nodes, until the log entry is eventually stored by all of the follower nodes. Once the leader node receives confirmation from the majority of its followers that the entry has been replicated, the leader node applies the entry to its local state machine, and the order is considered committed. This event also commits all previous entries in the leader node's log. Once a follower node learns that a log entry is committed, it applies the entry to its local state machine. This ensures consistency of the logs between all the nodes through the cluster. Thus, each transaction for digital assets, the exchange of assets, depositing and withdrawal of assets, assessment of fees, and other activities must be approved by consensus by the majority of the nodes 701-705 of the raft consensus network 302 in order for the transaction to be executed by the exchange 101. Note that execution of transactions by the exchange 101 require a consensus of the raft consensus network 302 in order for transactions to take place, as described in more detail with reference to process 500 above. Use of the raft algorithm results in redundancy of data since it implements log replication.

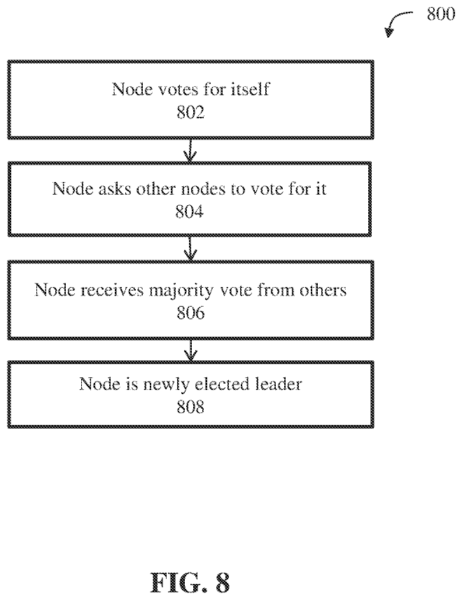

FIG. 8 is a flow chart depicting the control flow of a raft consensus process 800 in the system 100 for trustless trading of digital assets via a communications network 106, according to one embodiment. Note that the process 800 is undertaken automatically when the raft consensus network 302 enters into leader election mode, which occurs when the current leader of the raft consensus network 302 can no longer fulfill its required duties. A leader election is started by a candidate node. A node becomes a candidate if it receives no communication by the leader node over a period, so it assumes there is no acting leader node anymore.

The process 800 is depicted from the point of view of follower node 703 after the leader node 705 can no longer fulfill its required duties. The process 800 begins with step 802 wherein follower node 703 voting for itself to be leader, and in step 804 the follower node 703 transmitting a request for a vote (for itself) to the other follower nodes 701, 702, 704. In step 806, the node 703 receives a majority vote from the other follower nodes 701, 702, 704. In step 808, the node 703 is the newly elected leader node, and is recognized as such by the other nodes. Going forward, the duties of the leader node are carried out by node 703, until such time it can no longer fulfill its required duties.

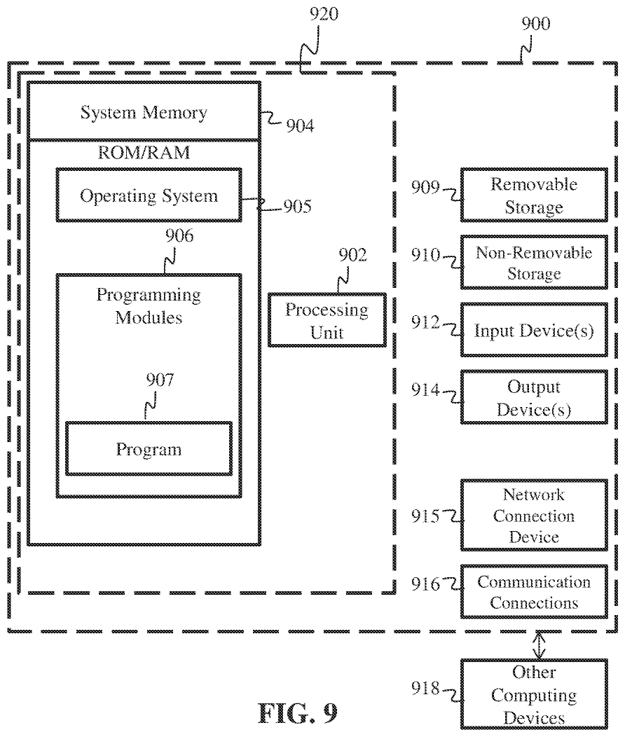

FIG. 9 is a block diagram of a system including an example computing device 900 and other computing devices. Consistent with the embodiments described herein, the aforementioned actions performed by 110, 112, 113, 302, may be implemented in a computing device, such as the computing device 900 of FIG. 9. Any suitable combination of hardware, software, or firmware may be used to implement the computing device 900. The aforementioned system, device, and processors are examples and other systems, devices, and processors may comprise the aforementioned computing device. Furthermore, computing device 900 may comprise an operating environment for system 100 and processes 500, 600, 800, as described above. Processes 500, 600, 800 may operate in other environments and are not limited to computing device 900.

With reference to FIG. 9, a system consistent with an embodiment may include a plurality of computing devices, such as computing device 900. In a basic configuration, computing device 900 may include at least one processing unit 902 and a system memory 904. Depending on the configuration and type of computing device, system memory 904 may comprise, but is not limited to, volatile (e.g. random-access memory (RAM)), non-volatile (e.g. read-only memory (ROM)), flash memory, or any combination or memory. System memory 904 may include operating system 905, and one or more programming modules 906. Operating system 905, for example, may be suitable for controlling computing device 900's operation. In one embodiment, programming modules 906 may include, for example, a program module 907 for executing the actions of 110, 112, 113, 302. Furthermore, embodiments may be practiced in conjunction with a graphics library, other operating systems, or any other application program and is not limited to any particular application or system. This basic configuration is illustrated in FIG. 9 by those components within a dashed line 920.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and nonvolatile, removable and non-removable media implemented in any method or technology for storage of information, such as computer-readable instructions, data structures, program modules, or other data. System memory 904, removable storage 909, and non-removable storage 910 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a camera, a touch input device, etc. Output device(s) 914 such as a display, speakers, a printer, etc. may also be included. Computing device 900 may also include a vibration device capable of initiating a vibration in the device on command, such as a mechanical vibrator or a vibrating alert motor. The aforementioned devices are only examples, and other devices may be added or substituted.

Computing device 900 may also contain a network connection device 915 that may allow device 900 to communicate with other computing devices 918, such as over a network in a distributed computing environment, for example, an intranet or the Internet. Device 915 may be a wired or wireless network interface controller, a network interface card, a network interface device, a network adapter or a LAN adapter. Device 915 allows for a communication connection 916 for communicating with other computing devices 918. Communication connection 916 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both computer storage media and communication media.

As stated above, a number of program modules and data files may be stored in system memory 904, including operating system 905. While executing on processing unit 902, programming modules 906 (e.g. program module 907) may perform processes including, for example, one or more of the stages of processes 500, 600, 800, as described above. The aforementioned processes are examples, and processing unit 902 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged, or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system configured for trustless trading of digital assets via a communications network, the system comprising:
a) a raft consensus-driven computer network comprised of a trusted execution environment (TEE) enclave within which processing of security-sensitive programs is secure from parties and operations outside the TEE enclave, and a rich execution environment (REE) for processing of non-security-sensitive programs, the raft consensus-driven computer network communicatively coupled to the communications network;
b) a software package for a digital asset exchange executed in the TEE enclave, the software package configured for executing transactions pertaining to digital assets as follows: 1) receiving, via the communications network, an order for a transaction regarding a particular digital asset; 2) transmitting, via the communications network, a request to an owner of said particular digital asset for an electronic signature authorizing said order; 3) receiving, via the communications network, an electronic signature from the owner authorizing said order; 4) verifying said electronic signature; and 5) executing said order for the transaction regarding the particular digital asset; and
c) wherein the raft consensus-driven computer network is configured for: 1) executing third party attestation on the software package executing in the TEE enclave; 2) documenting an outcome of the step of executing third party attestation via persistent storage of said outcome, wherein the outcome defines whether the software package executing in the TEE enclave is validated; and 3) subsequent to documenting said outcome, providing access, via the communications network, to said persistent storage of said outcome to parties and operations outside the TEE enclave.

2. The computing system of claim 1, wherein resources utilized by the TEE enclave are isolated from resources used by the REE.

3. The computing system of claim 2, wherein memory utilized by the TEE enclave is protected by a hardware access-control mechanism.

4. The computing system of claim 3, further comprising a secure communications channel between the REE and the TEE enclave.

5. The computing system of claim 4, wherein the step of transmitting a request to an owner further comprises transmitting a TCP request.

6. The computing system of claim 5, wherein the electronic signature comprises a digital signature.

7. The computing system of claim 6, wherein a digital asset comprises a digital currency.

8. A computing system configured for trustless trading of digital assets via a communications network, the system comprising:
a) a raft consensus-driven computer network comprised of trusted execution environment (TEE) enclaves within which processing of security-sensitive programs is secure from parties and operations outside the TEE enclaves, and a rich execution environment (REE) for processing of non-security-sensitive programs, the raft consensus-driven computer network communicatively coupled to the communications network, and wherein the raft consensus-driven computer network requires consensus of a majority of nodes in the raft consensus-driven computer network before transactions pertaining to digital assets are committed;
b) a software package for a digital asset exchange executed in the TEE enclaves, the software package configured for executing transactions pertaining to digital assets as follows: 1) receiving, via the communications network, an order for a transaction regarding a particular digital asset; 2) transmitting, via the communications network, a request to an owner of said particular digital asset for an electronic signature authorizing said order; 3) receiving, via the communications network, an electronic signature from the owner authorizing said order; 4) verifying said electronic signature; and 5) executing said order for the transaction regarding the particular digital asset; and
c) wherein the raft consensus-driven computer network is configured for: 1) executing third party attestation on the software package executing in the TEE enclaves; 2) documenting an outcome of the step of executing third party attestation via persistent storage of said outcome, wherein the outcome defines whether the software package executing in the TEE enclaves is validated; and 3) subsequent to documenting said outcome, providing access, via the communications network, to said persistent storage of said outcome to parties and operations outside the TEE enclaves.

9. The computing system of claim 8, wherein resources utilized by the TEE enclaves are isolated from resources used by the REE.

10. The computing system of claim 9, wherein memory utilized by the TEE enclaves is protected by a hardware access-control mechanism.

11. The computing system of claim 10, further comprising a secure communications channel between the REE and the TEE enclaves.

12. The computing system of claim 11, wherein the step of transmitting a request to an owner further comprises transmitting a TCP request.

13. The computing system of claim 12, wherein the electronic signature comprises a digital signature.

14. The computing system of claim 13, wherein a digital asset comprises a digital currency.
